(19) United States
(12) Patent Application Publication
(10) Pub. No.: US 2022/0383508 A1
(43) Pub. Date: Dec. 1, 2022

(54) IMAGE PROCESSING METHOD AND DEVICE, ELECTRONIC DEVICE, AND STORAGE MEDIUM

(71) Applicant: BEIJING DAJIA INTERNET INFORMATION TECHNOLOGY CO., LTD., Beijing (CN)

(72) Inventor: Xiaokun LIU, Beijing (CN)

(21) Appl. No.: 17/883,165

(22) Filed: Aug. 8, 2022

Related U.S. Application Data
(63) Continuation of application No. PCT/CN2020/127564, filed on Nov. 9, 2020.

(30) Foreign Application Priority Data
Apr. 23, 2020 (CN) 202010327149.6

(51) Int. Cl. G06T 7/194; G06T 7/136; G06T 7/143; G06T 7/11; G06V 10/44; G06V 20/00

(52) U.S. Cl. CPC G06T 7/194; G06T 7/136; G06T 7/143; G06T 7/11; G06V 10/443; G06V 20/38; G06T 2207/20081; G06T 2207/20084

(57) ABSTRACT

An image processing method, an image processing device, an electronic device, and a storage medium are provided. The method comprises: performing image segmentation on a first image which is to be processed, obtaining an initial mask image according to an image segmentation result, in response to determining that the first image satisfies a preset sky area replacement condition according to the initial mask image, obtaining a target mask image by performing guided filtering on the initial mask image by using a greyscale image of the first image as a guide image, acquiring a target sky scene, and obtaining a second image by performing replacement on the sky area in first the image according to the target mask image and the target sky scene.

### CROSS-REFERENCE TO RELATED APPLICATION

The present application is a continuation application of International Application PCT/CN2020/127564, filed Nov. 9, 2020, which claims priority to Chinese Patent Application No. 202010327149.6, titled “IMAGE PROCESSING METHOD AND APPARATUS, ELECTRONIC DEVICE, AND STORAGE MEDIUM”, filed Apr. 23, 2020, the entire disclosures of which are incorporated herein by reference.

### FIELD

The present disclosure relates to a technical field of image processing, and more particularly to an image processing method, an image processing device, an electronic device, and a storage medium.

### BACKGROUND

At present, artificial intelligence-based (AI-based) matting technology has been widely used in various application scenes, such as AI portrait blurring, AI partition scene recognition and so on. AI sky replacement (that is, replacing a sky area in an image with a sky area in a specific scene) is a typical scene of AI matting technology, and is also relatively challenging.

### SUMMARY

The present disclosure provides an image processing method, an image processing device, an electronic device and a storage medium to solve a problem that a completion rate of replacement of a sky area is not high in a related art to at least some extent.

According to a first aspect of the present disclosure, an image processing method is provided. The method includes: performing image segmentation on a first image which is to be processed; obtaining an initial mask image according to an image segmentation result, in which the initial mask image includes a probability value of each pixel point in the first image belonging to pixel points in a sky area; in response to determining that the first image satisfies a preset sky area replacement condition according to the initial mask image, obtaining a target mask image by performing guided filtering on the initial mask image by using a greyscale image of the first image as a guide image; acquiring a target sky scene, in which the target sky scene is selected from preset sky scene materials; and obtaining a second image by performing replacement on the sky area in the first image according to the target mask image and the target sky scene. According to a second aspect of the present disclosure, an electronic device is provided. The electronic device includes a processor, and a memory for storing instructions executable by the processor. The processor is configured to execute the instructions to perform the above-mentioned image processing method.

According to a third aspect of the present disclosure, a storage medium is provided. The storage medium has stored therein instructions that, when executed by a processor of an electronic device, cause the electronic device to perform the above-mentioned image processing method.

According to a fourth aspect of the present disclosure, a computer program product is provided. The program product includes a computer program, and the computer program is stored in a readable storage medium. When the computer program is read from the readable storage medium and executed by at least one processor of a device, the device is configured to perform the above-mentioned image processing method.

It should be understood that both the above general description and the following detailed description are explanatory and illustrative only and shall not be construed to limit the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure, and do not constitute an improper limitation of the present disclosure.

FIG. 1 is a schematic diagram showing an application environment of an image processing method according to an embodiment of the present disclosure.

FIG. 2 is a flow chart of an image processing method according to an embodiment of the present disclosure.

FIG. 3 is a schematic diagram showing a probability image according to an embodiment of the present disclosure.

FIG. 4 is a schematic diagram showing an image to be processed according to an embodiment of the present disclosure.

FIG. 5 is a schematic diagram showing a processed image according to an embodiment of the present disclosure.

FIG. 6 is a schematic diagram showing another processed image according to an embodiment of the present disclosure.

FIG. 7 is a flow chart of an image processing method according to another embodiment of the present disclosure.

FIG. 8 is a flow chart of an image processing method according to still another embodiment of the present disclosure.

FIG. 9 is a block diagram of an image processing device according to an embodiment of the present disclosure.

### DETAILED DESCRIPTION

In order to make those skilled in the art better understand the technical solutions of the present disclosure, the technical solutions in embodiments of the present disclosure will be described clearly and completely below with reference to the accompanying drawings.

It should be noted that the terms “first” and “second” in the specification, claims and the accompanying drawings of the present disclosure are used to distinguish similar objects, but shall not be used to describe a specific order or sequence. It should be understood that the terms so used may be interchangeable where appropriate, such that embodiments of the present disclosure described herein may be implemented in a sequence other than those illustrated or described herein. The embodiments described in the following illustrative examples are not intended to represent all embodiments consistent with the present disclosure. On the contrary, they are merely examples of devices and methods consistent with some aspects of the present disclosure as recited in the appended claims.

Since actual outdoor pictures taken by users cover and contain everything, and there are tree branches, birds, buildings, wires, flags, windmills, glass, etc. in sky, it is not easy to accurately separate a sky area from a non-sky area. Especially in a scene where there are details in a sky, such as a sky between tree branches, a sky with wires and the like, it is difficult to segment the sky area.

The current “sky replacement” function is mainly to determine a sky area through AI matting and then perform post-processing. However, the segmentation effect of the current technology is poor, resulting in inaccurate determination of the sky area and unnatural transition of the sky edge caused by an imperfect post-processing, and thus a completion rate of the image is low.

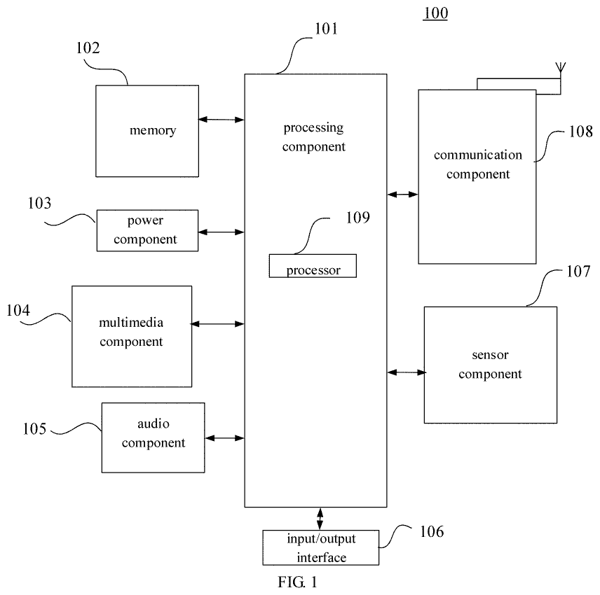

An image processing method provided in an embodiment of the present disclosure may be applied to an electronic device as shown in FIG. 1. The electronic device may be a personal computer, a laptop, a smartphone, a tablet and a portable wearable device. Referring to FIG. 1, the electronic device 100 may include one or more of the following components: a processing component 101, a memory 102, a power component 103, a multimedia component 104, an audio component 105, an input/output (I/O) interface 106, a sensor component 107, and a communication component 108.

The processing component 101 typically controls overall operations of the electronic device 100, such as operations associated with display, telephone calls, data communications, camera operations, and recording operations. The processing component 101 may include one or more processors 109 to execute instructions to perform all or part of the steps in the above described method. Moreover, the processing component 101 may include one or more modules which facilitate interaction between the processing component 101 and other components. For instance, the processing component 101 may include a multimedia module to facilitate interaction between the multimedia component 104 and the processing component 101.

The memory 102 is configured to store various types of data to support the operation of the electronic device 100. Examples of such data include instructions for any applications or methods operated on the electronic device 100, contact data, phonebook data, messages, pictures, videos, etc. The memory 102 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power component 103 provides power to various components of the electronic device 100. The power component 103 may include a power management system, one or more power sources, and any other components associated with the generation, management, and distribution of power in the electronic device 100.

The multimedia component 104 includes a screen providing an output interface between the electronic device 100 and a user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 104 includes a front camera and/or a rear camera. The front camera and the rear camera may receive external multimedia data while the electronic device 100 is in an operation mode, such as a photographing mode or a video mode. Each of the front camera and the rear camera may be a fixed optical lens system or have focus and optical zoom capability.

The audio component 105 is configured to output and/or input audio signals. For example, the audio component 105 includes a microphone (MIC) configured to receive an external audio signal when the electronic device 100 is in an operation mode, such as a call mode, a recording mode, and a voice recognition mode. The received audio signal may be further stored in the memory 102 or transmitted via the communication component 108. In some embodiments, the audio component 105 further includes a speaker to output audio signals.

The I/O interface 106 provides an interface between the processing component 101 and a peripheral interface module, such as a keyboard, a click wheel, buttons, and the like. The buttons may include, but are not limited to, a home button, a volume button, a starting button, and a locking button.

The sensor component 107 includes one or more sensors to provide status assessments of various aspects of the electronic device 100. For instance, the sensor component 107 may detect an open/closed status of the electronic device 100, relative positioning of components, e.g., the display and the keyboard, of the electronic device 100, a change in position of the electronic device 100 or a component of the electronic device 100, a presence or absence of user contact with the electronic device 100, an orientation or an acceleration/deceleration of the electronic device 100, and a change in temperature of the electronic device 100. The sensor component 107 may include a proximity sensor configured to detect a presence of nearby objects without any physical contact. The sensor component 107 may also include a light sensor, such as a CMOS or CCD image sensor, for use in imaging applications. In some embodiments, the sensor component 107 may also include an accelerometer sensor, a gyroscope sensor, a magnetic sensor, a pressure sensor, or a temperature sensor.

The communication component 108 is configured to facilitate communication, wired or wireless, between the electronic device 100 and other devices. The electronic device 100 may access a wireless network based on a communication standard, such as WiFi, an operator network (such as 2G 3G; 4G or 5G) or a combination thereof In one exemplary embodiment, the communication component 108 receives a broadcast signal or broadcast associated information from an external broadcast management system via a broadcast channel. In one exemplary embodiment, the communication component 108 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the electronic device 100 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

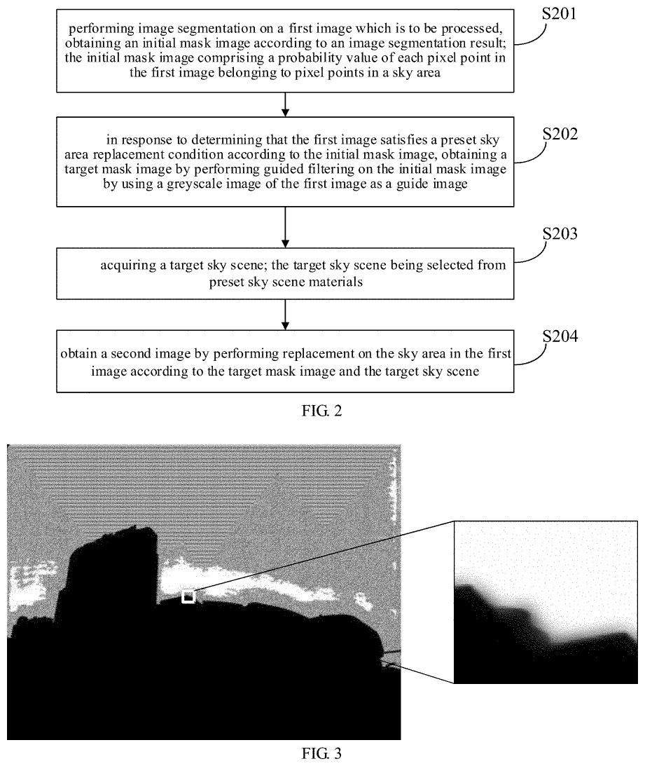

FIG. 2 is a flow chart of an image processing method according to an embodiment of the present disclosure. As shown in FIG. 2, the image processing method is applied to the electronic device as shown in FIG. 1, and includes steps as follows.

In step S201, image segmentation is performed on an image to be processed, and an initial mask image is obtained according to an image segmentation result. The initial mask image includes a probability value of each pixel point in the image to be processed belonging to pixel points in a sky area.

The image to be processed is an image in which a sky area needs to be replaced, which may be an image input by a user through a client (for example, an image downloaded through the client, an image captured by a camera on the client, etc.), an image obtained in advance, or an image obtained in real time, and thus the image to be processed may be also called an input image. The image to be processed may be an image with a scene containing a sky area (the sky area may be large or small) in various formats. The sky area refers to an area belonging to the sky, which may be a sky on a sunny day, on a cloudy day, after rain, in an evening, at night, with a rainbow, and so on. In addition to the sky area, there could also be other areas such as buildings and hills in the image to be processed. In addition, a size and a shape of the image to be processed may be various.

Performing the image segmentation on the image to be processed may refer to performing classification of an area where pixels are located in the image, that is, the image is divided into mutually non-intersecting areas. In recent years, with the gradual development of deep learning technology, the image segmentation technology has developed by leaps and bounds. The related technologies, such as scene-object segmentation, human body foreground and background segmentation, have been widely used in unmanned driving, augmented reality, security monitoring and other industries. Further, according to some embodiments of the present disclosure, the image to be processed may be segmented by deep learning. For example, the probability value of each pixel in the image to be processed belonging to the sky area is determined by a neural network model, such that the sky area of the image to be processed may be segmented. The probability value may be determined according to actual situations, and the higher the value is, the more likely the pixel point belongs to the sky area (that is, belongs to the pixel points in the sky area). For example, a value of 1 denotes that the pixel point definitely belongs to the sky area, a value of 0 denotes that the pixel point definitely does not belong to the sky area, and a value of 0.9 denotes that there is a 90% probability that the pixel point belongs to the sky area. In some embodiments, the probability value may be understood as mask information of the corresponding pixel point. Therefore, the probability value may be called a mask value, and accordingly the initial mask image may also be called a probability mask image.

Further, after obtaining the probability value of each pixel point, each probability value may be arranged according to a position of the pixel point to obtain the initial mask image. In addition, the probability value of each pixel point may also be converted into a corresponding greyscale value. For example, the probability value of 1 may be converted into a greyscale value of 255, the probability value of 0.5 may be converted into a greyscale value of 127, and the probability value of 0 may be converted into a greyscale value of 0. In this way, a greyscale image corresponding to the probability value may be output, and the electronic device may obtain the corresponding probability value after obtaining the greyscale value of the initial mask image. The initial mask image displayed in the interface may be as shown in FIG. 3.

In step S202, in response to determining that the image to be processed satisfies a preset sky area replacement condition according to the initial mask image, a target mask image is obtained by performing guided filtering on the initial mask image by using the greyscale image of the image to be processed as a guide image.

The sky area replacement condition may be determined according to a size of the sky area, confidence degree, a scene of the image to be processed, and the like. In some embodiments, when the image to be processed meets at least one of a too small sky area, a non-confidence image to be processed, a night scene, and a foggy scene, it may be considered that the sky area replacement condition is not satisfied.

The initial mask image is obtained by image segmentation, and the image segmentation will perform quantization on each pixel point, and thus the quantization may make difference between probability values of adjacent pixels inaccurate, which will easily cause a separation sense between various areas of the image. For image segmentation through the neural network model, downsampling will reduce resolution of the image, for example, one pixel point becomes five pixel points. However, the initial mask image and the greyscale image are input into an algorithm of the guided filtering, which may fuse the information of the initial mask image and the greyscale image. For example, if there is a large color gradient between a building and a sky in an input image, and difference in probability values between the building and the sky in the initial mask image is small, the guided filtering may be performed to correct the above-mentioned problem in the initial mask image. On the contrary, if there is a small color gradient between leaves and the sky in the input image, and difference in probability values between the leaves and the sky in the initial mask image is large, the guided filtering may be also performed to correct the above-mentioned problem in the initial mask image. Therefore, a feathering effect in the initial mask image may be achieved through guided filtering, such that an output processed image is closer to the input image, thereby achieving a more realistic and natural sky replacement effect. The initial mask image after guided filtering may be shown in a partial enlarged image on the right side in FIG. 3, and it could be seen that information of the initial mask image and the greyscale image may be fused by an algorithm, thereby achieving the feathering effect (gradual transition from a black area to a white area) to prevent a sense of separation and blunting in the obtained image.

In step S203, a target sky scene is acquired. The target sky scene is selected from preset sky scene materials.

The target sky scene refers to a type of a sky to be replaced. The sky scene materials may refer to scenes such as a scene on a sunny day, on a cloudy day, after rain, with a rainbow, with sunset clouds, in an evening, at night and so on. In this step, the target sky scene is selected from the sky scene materials, such that the image to be processed may be processed in a targeted manner. Further, the target sky scene may be obtained according to scene selection information input by the user. For example, if the scene selection information is “sunset clouds”, the target sky scene may be a scene with sunset clouds.

In step S204, a first processed image is obtained by performing replacement on the sky area in the image to be processed according to the target mask image and the target sky scene.

The performing replacement on the sky area may be implemented by the following steps. The sky area in the target mask image is determined to obtain the target sky scene. According to the target sky scene, a target sky image (that is, a sky image used for replacement) is obtained, and the sky area is replaced with the target sky image. The replaced image may be regarded as an image after replacing the sky area, that is, the first processed image. The target sky image may be a sky image obtained from a sky material library according to the target sky scene. For example, if the target sky scene is a scene with sunset clouds, the target sky image may be a sky image having a sunset scene.

In some embodiments, a shape and a size of the target sky image may be determined according to a shape and a size of the sky area, and the shape and size of the two may be consistent or inconsistent. For example, a distance between each edge of the target sky image and each edge of the sky area is 50 pixel points, that is, the target sky image is larger than the sky area.

In the above-mentioned method, the image segmentation is performed on the image to be processed, and the initial mask image containing the probability value of each pixel point in the image to be processed belonging to the pixel points in the sky area is obtained according to the image segmentation result, such that the sky area may be accurately determined according to the initial mask image. If the image to be processed satisfies the preset sky area replacement condition according to the initial mask image, the guided filtering is performed on the initial mask image by using the greyscale image of the image to be processed as the guide image to obtain the target mask image. The guided filtering may achieve the feathering effect on the initial mask image, and effectively correct the color gradient between adjacent image areas in the initial mask image, resulting in a real and natural replacement effect of the sky in the processed image obtained according to the target mask image, and a high completion rate.

In some embodiments, performing guided filtering on the initial mask image by using the greyscale image of the image to be processed as the guide image to obtain the target mask image includes the following steps. A blue channel pixel value of each pixel point in the image to be processed is acquired. It is determined as a first pixel point a pixel point having a blue channel pixel value within a target distribution interval and a probability value greater than a first threshold in the initial mask image. The target distribution interval is an interval having a largest number of blue channel pixel values of pixel points in a first evaluation area among a plurality of preset intervals, and the first evaluation area is an area where a pixel point having a probability value greater than a second threshold is located in the initial mask image. The second threshold is greater than the first threshold. It is determined as a second pixel point a pixel point having a blue channel pixel value less than a target blue channel pixel value in the initial mask image. The target blue channel pixel value is a minimum value of blue channel pixel values of pixel points in a second evaluation area, and the second evaluation area is an area where a pixel point having a probability value greater than a third threshold in the initial mask image is located. The third threshold is greater than the second threshold. A probability value of the first pixel point is increased and a probability value of the second pixel point is decreased to obtain a reference mask image. The guided filtering is performed on the reference mask image by using the greyscale image of the image to be processed as the guide image to obtain the target mask image.

The first evaluation area may be an area in the initial mask image that is most likely to be the sky area. Therefore, the second threshold may be a relatively large value to ensure the accuracy of the selected first evaluation area as much as possible. In some embodiments, the second threshold may be 0.9, 0.92, or the like. Further, after determining the first evaluation area, the blue channel pixel value of each pixel point in the first evaluation area may be classified into a set interval, and the interval may be divided from 0 to 255 according to actual situations. The interval having the largest number of the blue channel pixel values is determined as the target distribution interval.

Further, the first pixel point may be determined in combination with the target distribution interval and the probability value. For example, the pixel point having the blue channel pixel value within the target distribution interval and the probability value greater than the preset threshold in the initial mask image is determined as the first pixel point. The preset threshold may be determined according to actual situations, such as 0.5. In this way, the first pixel point may be more accurately determined in combination with the blue channel pixel value and the probability value, thereby improving the replacement accuracy of the sky area. The blue channel pixel value is a value corresponding to a Blue (B) channel in an RGB value.

In some embodiments, in addition to increasing the probability value of the area that is most likely to be the sky area, it is also possible to decrease a probability value of an area that is least likely to be the sky area. The second evaluation area may be an area in the initial mask image that is likely to be the sky area. In order to prevent the pixel points in the non-sky area from being classified into the sky area, the third threshold may be a relatively large value, even greater than the second threshold. In some embodiments, the third threshold may be 0.93, 0.95, or the like. In this way, an area may be considered as much as possible to determine a target blue channel pixel value therefrom, and the target blue channel pixel value is determined as an upper limit to determine the second pixel point in the initial mask image. The target blue channel pixel value corresponding to the second evaluation area may be understood as a lowest critical point of the blue channel pixel value of the sky area. If a blue channel pixel value of a certain pixel point is less than the critical point, it is determined that the pixel point does not belong to the sky area, and the probability value is decreased. The second pixel point is determined according to the target blue channel pixel value, such that it is possible to effectively prevent the non-sky area from being omitted and being classified into the sky area.

In some embodiments, the second threshold and the third threshold may also be the same, and even the third threshold may also be smaller than the second threshold. On another hand, increasing the probability value may refer to assigning to the probability value a larger value, such as 1, 0.99, 0.98, or the like, and decreasing the probability value may refer to assigning to the probability value a smaller value, such as 0.5, 0.6, or the like. For example, for a pixel point with a probability value of 0.9, if it is determined that it is most likely to belong to the sky area according to the blue channel pixel value (for example, the value corresponding to the blue channel B is larger), the probability value may be assigned a value of 1. For a pixel point with a probability value of 0.5, if it is determined according to the color channel information that it is least likely to belong to the sky area, the probability value may be decreased by half or to 0.

In some embodiments, the decreasing the probability value of the pixel point by half may be uniformly subtracting a certain probability value, for example, uniformly subtracting 0.1, 0.2, or the like.

In the above-mentioned embodiments, the probability value of the pixel point that is most likely to be in the sky area is increased, and the probability value of the pixel point that is least likely to be in the sky area is decreased, which highlights the probability value of the sky area, such that the sky area to be replaced may be accurately identified to perform sky replacement, thereby improving the replacement accuracy of the sky.

In some embodiments, increasing the probability value of the first pixel point and decreasing the probability value of the second pixel point includes: setting the probability value of the first pixel point as 1, and decreasing the probability value of the second pixel point by half.

In some embodiments, increasing and decreasing the probability value of the pixel point may be performed as follows. A histogram of a blue channel pixel value of each pixel in an area with a probability value more than 0.9 in the image to be processed is calculated. An interval having a largest number of blue channel pixel values is determined among Q1:0-63, Q2:64-127, Q3:128-191 and Q4:192-255 according to the histogram, and the interval having the largest number of pixel points is determined as a target distribution interval, denoted as Qi. A probability value of a pixel point having a blue channel pixel value within the target distribution interval Qi and a probability value greater than 0.5 is set as 1.0. The interval may be divided according to actual situations, such as, may be divided into larger or smaller intervals.

In the above-mentioned embodiments, the probability value of the first pixel point that is most likely to be in the sky area is determined as 1, and the probability value of the second pixel point that is least likely to be in the sky area is determined as 0, which highlights the probability value of the sky area, such that the sky area to be replaced may be accurately identified to perform sky replacement, thereby improving the replacement accuracy of the sky.

In some embodiments, in addition to determining the first pixel point and the second pixel point according to the blue channel pixel value, they may also be determined according to pixel values of other channels, such as a red channel pixel value, a green channel pixel value or the like. In some embodiments, for replacing a sky in a scene in an evening, the red channel pixel value may be used, such that a more accurate sky area in the scene may be determined in some embodiments, thereby replacing the sky area accurately and improving a completion rate.

Further, in some embodiments, the probability value of the second pixel point may be first decreased, and then the probability value of the first pixel point in the probability image after decreasing the probability value may be increased, thereby obtaining a candidate mask image. In some embodiments, it is also possible to increase the probability value of the first pixel point in the initial mask image and decrease the probability value of the second pixel point in the initial mask image, respectively, and the obtained probability image in the two manners are integrated to obtain a candidate mask image. For example, for a pixel point that has not changed in the initial mask image, its original probability value is retained; for a probability value that is only increased or is only decreased, the processed probability value is retained; and for a probability value that is both increased and decreased, an average value of the probability values obtained in the two manners may be taken. Then, the guided filtering is performed on the candidate mask image by using the greyscale image of the image to be processed as the guide image to obtain the target mask image.

In some embodiments, performing replacement on the sky area in the image to be processed according to the target mask image and the target sky scene to obtain the first processed image includes: determining a non-sky area in the image to be processed as a foreground image, cropping a sky material image according to the target sky scene and a size of the sky area to obtain a target sky image having a scene corresponding to the target sky scene and a size corresponding to the size of the sky area, and composing the foreground image and the target sky image according to the target mask image to obtain the first processed image. The sky area in the first processed image is replaced by the target sky image.

Determining the non-sky area in the image to be processed may be determining a pixel point with a probability value less than 0.85 (which may be other values, or be determined in combination with the blue channel pixel value) as a pixel point in the non-sky area, and integrating the pixel points in the non-sky area to obtain the non-sky area, for example, by integrating scattered points into a complete area.

In some embodiments, the target sky image may be acquired by the following steps. A minimum rectangular bounding box of the sky area is determined, and a candidate sky material image corresponding to the target sky scene is acquired from the sky material images. The target sky image is cropped from the candidate sky material image while maintaining an aspect ratio.

Further, the target sky image may be cropped in a way of center cropping or other ways. For example, a center point of the candidate sky material image is determined, and the center point is taken as a center to crop the target sky image to the size of the rectangular bounding box. Furthermore, in order to obtain the target sky image, the candidate sky material image may be scaled and then cropped, or the candidate sky material image may be first cropped and then be scaled in size.

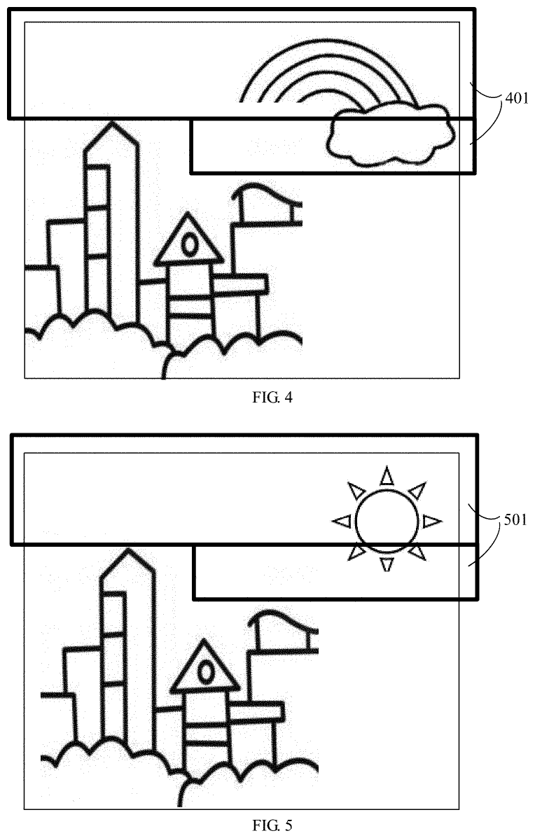

The foreground image and the target sky image may be composed according to the target mask image to obtain the processed image by the following steps. An area having a size consistent with a size of the image to be processed in a blank area is determined as an area to be filled. The sky area is determined in the area to be filled according to the target mask image, the target sky image is filled into the sky area, and the foreground image is filled into the remaining area to obtain the processed image. In some embodiments, the sky area is determined in the image to be processed according to the target mask image, the target sky image is filled into the sky area, and the foreground image is filled into the remaining area to obtain the processed image. If there is an overlapping area between the foreground image and the target sky image after area filling is completed, probability values in the overlapping area may be integrated to obtain a final probability value, and then area filling may be performed according to the final probability value. For example, if it is determined to be the sky area (for example, the probability value greater than 0.5), the target sky image is filled, and if it is determined to be the non-sky area, the foreground image is filled. FIG. 4 shows the image to be processed in some embodiments. An area formed by two rectangular boxes represents a sky area 401, and the sky area 401 is currently a rainbow scene.

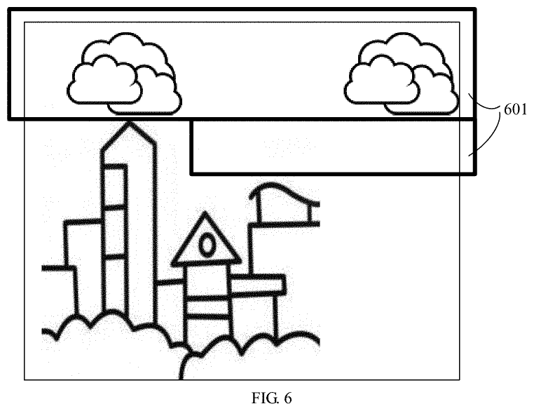

FIG. 5 shows a sunny scene after replacing. As shown in FIG. 5, the sky area 401 of the rainbow scene is replaced with the sky area 501 of the sunny scene. FIG. 6 shows a cloudy scene after replacing. As shown in FIG. 6, the sky area 401 of the rainbow scene is replaced with the sky area 601 of the cloudy scene.

It could be seen from the above-mentioned processes that the sky area has been replaced with the target sky image, that is, the replacement of the sky area has been realized, while buildings (foreground image) in the image have not been replaced. By the above-mentioned processes, the sky area and the foreground image may be effectively distinguished, which effectively prevents image contents from overlapping, and ensures clarity of the obtained processed image while satisfying user requirements.

Further, in some embodiments, performing replacement on the sky area in the image to be processed according to the target mask image and the target sky scene to obtain the first processed image includes the following steps. A first area, a second area and a remaining area of the image to be processed are determined according to the target mask image. A probability value of a pixel point contained in the first area is 1, a probability value of a pixel point contained in the second area is 0, and the remaining area is an area other than the first area and the second area in the image to be processed. The first area is replaced with the target sky image. The second area is replaced with the foreground image. According to a probability value, a red channel pixel value, a green channel pixel value and a blue channel pixel value corresponding to the remaining area, color channel information fusion is performed on pixel points of the foreground image and the target sky image. The first processed image is obtained according to the target sky image after performing the color channel information fusion.

The first area may refer to an area that is most likely to be or definitely a sky area, and the second area may refer to an area that is least likely to be a sky area or is definitely not a sky area. It should be noted that, in the above-mentioned case that the probability value is 1, the probability value may also be replaced with other values, such as 0.98, 0.99, or the like, and in the above-mentioned case that the probability value is 0, the probability value may also be replaced with other values, such as 0.02, 0.01, or the like.

The color channel information may refer to values corresponding to three channels of RGB in the image, and color of the corresponding pixel point may be obtained according to the color channel information. Further, the color channel information may be values corresponding to a certain channel or multiple channels. In some embodiments, the color channel information may include a red channel pixel value, a green channel pixel value and a blue channel pixel value. The fusion of the foreground image and the target sky image may refer to performing arithmetic processing, such as multiplication, gamma transformation on the color channel information corresponding to the foreground image and the target sky image, and the color channel information obtained after processing may be determined as the color channel information of the corresponding pixel point. The color channel information may be all or part of the information in the RGB value. For example, the multiplication may refer to multiplying the RGB values of the corresponding pixel points in the foreground image and the target sky image, and the gamma transformation may refer to performing exponentiation on the RGB values of the corresponding pixel points in the foreground image and the target sky image.

In some embodiments, composing the foreground image and the target sky image according to the target mask image to obtain the first processed image includes the following steps. At least one of brightness, contrast and saturation of the foreground image is adjusted according to the target sky scene to obtain a target foreground image having brightness, contrast and saturation matching that of the target sky scene. The target foreground image and the target sky image are composed according to the target mask image to obtain the first processed image. The first processed image obtained by such steps may be adapted to the style of the target sky scene. In addition, filter beautification may also be performed on the foreground image to obtain the target foreground image.

In some embodiments, the method in above-mentioned embodiment may also be implemented by the following steps.

The target sky image is directly used for an area with a probability value of 1.0, and the foreground image is directly used for an area with a probability value of 0.0. It should be noted that a position and an angle of the image should match the corresponding area during replacement. For example, a building in a vertical state needs to be still in a vertical state in the first processed image after being replaced.

An area with a probability value between 0.0 and 1.0 may be processed by the following steps.

First, the target sky image and the foreground image are composed according the probability value. A mixRGB value of a composed pixel point A is obtained by the following formula:

mixRGB=src*(1.0−mask)+sky*mask;

where src represents an RGB value of a pixel point A in a foreground image, mask represents a probability value of the pixel point A in a reference probability image, and sky represents an RGB value of the pixel point A in a target sky image.

Then, the multiplication and the gamma transformation are performed on the mixRGB to obtain a tempRGB value by the following formula:

tempRGB=sqrt(mixRGB*sky, 0.5);

where 0.5 is a preset parameter, or may also be set as other values according to actual needs.

Finally, a pixel point with a probability value between 0.5 and 1.0 is fused by the following formula:

resRGB=sky*(2.0*mask−1.0)+tempRGB*(2.0−2.0*mask).

A pixel point with a probability value between 0.0 and 5.0 is fused by the following formula:

resRGB=tempRGB*(2.0*mask−1.0)+src*(2.0−2.0*mask).

Other pixel points are fused in the same way as above.

During composing the foreground image and the target sky image, the area that is definitely the sky area is replaced with the target sky image, and the area that is definitely not the sky area is replaced with the foreground image. After the above-mentioned processing, if an area between the foreground image and the target sky image is not processed, there will be a separation sense where the foreground suddenly switches to the sky area. In some embodiments of the present disclosure, an area in a middle area that is neither the foreground image nor the target sky image is fused, and the fused area integrates the color channel information of the sky area and the non-sky area, which may ensure a natural transition from the foreground to the sky, thereby obtaining a more real and natural image.

In some embodiments, after completing the replacement of the sky area, the image processing method may further include correcting the processed image. For example, the processed image is compared with the image to be processed. If the foreground image or the target sky image has position and angle deviations, it is possible to adjust the processed image; or if there is an unnatural edge transition, it is also possible to adjust the processed image. In this way, the final output processed image may have a high accuracy and a replacement effect of the sky area, thereby improving the completion rate.

In some embodiments, performing the image segmentation on the image to be processed and obtaining the initial mask image according to the image segmentation result includes: performing image segmentation on the image to be processed through a pre-trained neural network model to obtain an image segmentation result, determining a probability value of each pixel point in the image to be processed belonging to the pixel points in the sky area according to the image segmentation result, and obtaining the initial mask image according the probability value of each pixel point in the image to be processed.

The neural network model may be a convolutional neural network (CNN) model. In some embodiments, the neural network may be u-net, u-net variants, is-net, deeplab series, etc.

Further, in some embodiments, performing the image segmentation on the image to be processed through the pre-trained neural network model includes: scaling a size of the image to be processed to a preset size, performing normalization on the scaled image to be processed, and performing the image segmentation on the normalized image to be processed through the pre-trained neural network model.

The preset size may be determined according to actual needs, such as 512*512 or 768*768. The normalization may be performed by obtaining an image sample, determining an average value and a variance of RGB values of each pixel point of the image sample, and subtracting the average value from and dividing the variance into the RGB values of each pixel point of the image to be processed. In this way, machine learning and feature learning may be better performed, so as to classify whether each pixel point in the image to be processed belongs to the pixel points in the sky area to obtain the probability image.

The neural network model may be obtained by training a predetermined training image. The trained neural network model may downsample the image to be processed, and then extract feature information therein, analyze the feature information, and output the image segmentation result. At this time, a computer device may determine the probability value of each pixel point belonging to the sky area according to the image segmentation result to obtain the initial mask image. Compared with the traditional image segmentation (graph cut), the neural network model fully analyzes the feature information in the image to be processed, and machine learning may more accurately segment the image to be processed, thereby obtaining the probability image accurately.

In some embodiments, the image to be processed is first preprocessed upon obtaining the image to be processed, and then network segmentation is performed through the neural network model to obtain the initial mask image, and thus the sky area may be accurately distinguished from the image to be processed according to the initial mask image, which may be understood as a post-processing process. The network segmentation and the post-processing are combined, which may retain an accurate segmentation effect of the neural network model. On this basis, the post-processing is performed to accurately distinguish the sky area and non-sky area, resulting in a more accurate replacement of the sky area.

In some embodiments, determining whether the image to be processed satisfies the preset sky area replacement condition according to the initial mask image includes determining whether the image to be processed satisfies at least one of the following preset conditions according to the initial mask image. If at least one of the following preset conditions is satisfied, it is determined that the image to be processed does not satisfy the sky area replacement condition. If any one of the following preset conditions is not satisfied, it is determined that the image to be processed satisfies the sky area replacement condition. A first proportion of the sky area in the image to be processed is determined. If the first proportion is less than a preset fourth threshold, it is determined that the sky area is too small. A second proportion of a non-confidence area in the image to be processed is determined. If the second proportion is greater than a preset fifth threshold, it is determined to be non-confidence. The non-confidence area is an area where a probability value of each pixel point is in a middle interval, and the middle interval consists of a median of the probability values and adjacent values of the median. An average brightness of the sky area in the image to be processed is determined. If the average brightness is less than a preset sixth threshold, it is determined as a night scene. A third proportion of a target dark channel area in the image to be processed is determined. If the third proportion is greater than a preset seventh threshold, it is determined as a foggy scene. The target dark channel area is an area in the sky area where a pixel point having a dark channel value less than an eighth threshold is located.

The fourth threshold, the fifth threshold, the sixth threshold, the seventh threshold and the eighth threshold may be determined according to actual situations. For example, the fourth threshold may be 0.9, the fifth threshold may be 0.1, the sixth threshold may be 0.3 cd/m², and the seventh threshold may be 0.4, and the eighth threshold may be 0.8.

A pixel point with a probability value of 1 may be understood as definitely belonging to the sky area, a pixel point with a probability value of 0 may be understood as definitely not belonging to the sky area, and a pixel with an intermediate probability value (for example, 0.5) belongs to an uncertain area, that is the non-confidence area, which may belong to the sky area or may not belong to the sky area. In some embodiments, the non-confidence area may be an area with a probability value between 0.3 and 0.7, and boundary values of the interval may also be other values. It should be noted that, in some embodiments of the present disclosure, if a sky area needs to be determined, an area with a probability value greater than 0.9 (or other values) may be extracted from the probability image obtained in the current step as the sky area. The sky areas in different embodiments may be the same or different.

The average brightness of the sky area in the image to be processed may be determined by calculating an average greyscale value of an area in an original image (the image to be processed) corresponding to an area with a probability value greater than 0.9 in the initial mask image. After determining a dark channel value of the sky area, a dark channel image may be obtained, and then it is determined whether the image to be processed is a foggy scene based on the dark channel image. For an RGB image, the dark channel value is a minimum value of three RGB values. For example, if R, G and B values are 10, 20 and 30, respectively, the dark channel value is 10. If a proportion of an area with a dark channel value less than a certain threshold is greater than the seventh threshold, it is determined to be a foggy sky. The third proportion of the target dark channel area may be understood as statistical information of the dark channel value.

In some embodiments, the above-mentioned processes may be implemented through the following steps.

(i) The first proportion of the sky area in the whole image to be processed is counted according to the initial mask image. If the first proportion is less than 0.9, it is determined that the sky area is too small.

(ii) The average brightness of the sky area in the image to be processed is counted according to the initial mask image. If the average brightness is less than a threshold of 0.3 cd/m², it is determined as a night scene.

(iii) The second proportion of the area having the probability value between 0.3 and 0.7 in the whole image to be processed is counted according to the initial mask image. If the second proportion is greater than a threshold of 0.1, it is determined that the initial mask image is non-confidence.

(iv) A dark channel image of the sky area in the image to be processed is obtained according to the initial mask image, and it is determined whether it is foggy based on statistical information of the dark channel image. If the third proportion of the target dark channel value is less than 0.8, it is determined as a foggy scene.

If at least one of the above-mentioned preset conditions is satisfied, it may be determined that the image to be processed is not suitable for the replacement of the sky area, that is, it is not suitable for replacing the sky. Otherwise, if none of the above-mentioned conditions are satisfied (or most of them are not satisfied), it may be determined that it is suitable to replace the sky, and the subsequent replacement of the sky may be performed.

Further, in some embodiments, after determining whether the image to be processed satisfies the preset sky area replacement condition according to the initial mask image, the image process method further includes acquiring a target filtering tool according to the target sky scene in response to the sky area replacement condition being not satisfied, and performing filtering on the image to be processed by the target filtering tool to obtain a second processed image.

In some embodiments, if the image to be processed does not satisfy the sky area replacement condition, a predetermined target sky scene is acquired, a comprehensive filter corresponding to the target sky scene is selected, and the image to be processed is processed through the comprehensive filter to obtain the second processed image.

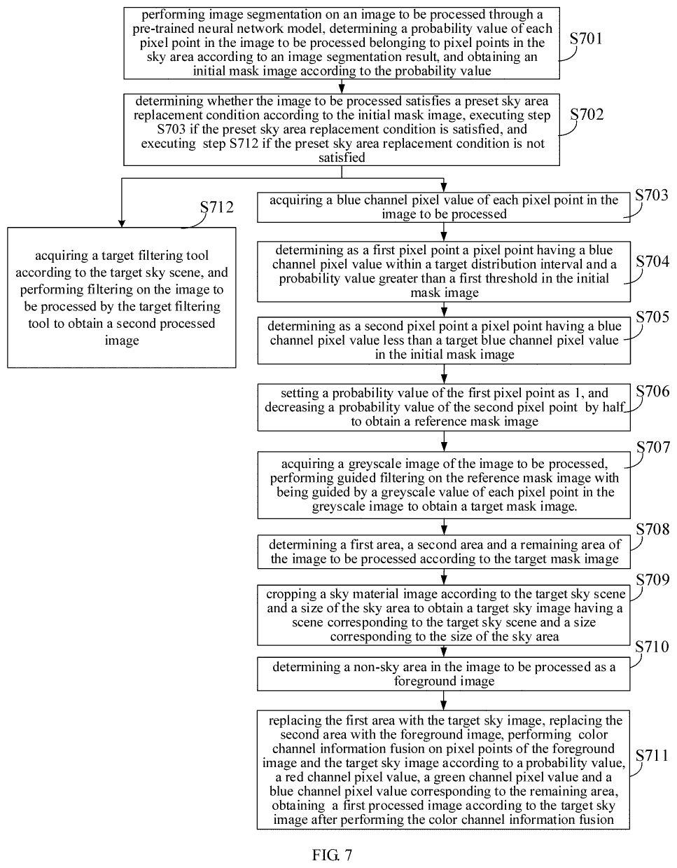

In some embodiments, as shown in FIG. 7, an image processing method is provided, and includes steps as follows.

In step S701, image segmentation is performed on an image to be processed through a pre-trained neural network model, a probability value of each pixel point in the image to be processed belonging to pixel points in the sky area is determined according to an image segmentation result, and an initial mask image is obtained according to the probability value.

In step S702, it is determined whether the image to be processed satisfies a preset sky area replacement condition according to the initial mask image. If the preset sky area replacement condition is satisfied, step S703 is executed, and if the preset sky area replacement condition is not satisfied, step S712 is executed.

In step S703, a blue channel pixel value of each pixel point in the image to be processed is acquired.

In step S704, a pixel point having a blue channel pixel value within a target distribution interval and a probability value greater than a first threshold in the initial mask image is determined as a first pixel point.

In step S705, a pixel point having a blue channel pixel value less than a target blue channel pixel value in the initial mask image is determined as a second pixel point.

In step S706, a probability value of the first pixel point is set as 1, and a probability value of the second pixel point is decreased by half to obtain a reference mask image.

In step S707, a greyscale image of the image to be processed is acquired, and guided filtering is performed on the reference mask image with being guided by a greyscale value of each pixel point in the greyscale image to obtain a target mask image.

In step S708, a first area, a second area and a remaining area of the image to be processed are determined according to the target mask image.

In step S709, a sky material image is cropped according to the target sky scene and a size of the sky area to obtain a target sky image having a scene corresponding to the target sky scene and a size corresponding to the size of the sky area.

In step S710, a non-sky area in the image to be processed is determined as a foreground image.

In step S711, the first area is replaced with the target sky image, and the second area is replaced with the foreground image; color channel information fusion is performed on pixel points of the foreground image and the target sky image according to a probability value, a red channel pixel value, a green channel pixel value and a blue channel pixel value corresponding to the remaining area; and a first processed image is obtained according to the target sky image after performing the color channel information fusion.

In step S712, a target filtering tool is acquired according to the target sky scene, and the image to be processed is filtered by the target filtering tool to obtain a second processed image.

In the above-mentioned image processing method, the image segmentation is performed on the image to be processed to accurately obtain the initial mask image containing the probability value of each pixel point in the image to be processed belonging to the sky area. According to the blue channel pixel value of each pixel point in the image to be processed, the probability value of the pixel point corresponding to the sky area in the initial mask image is increased, and the reference probability image is obtained. The obtained reference probability image further expands the probability value difference between the sky area and the non-sky area. The sky area in the image to be processed is accurately identified according to the reference probability image, and thus the processed image obtained according to the replacement of the sky area has high accuracy, resulting in a natural replacement effect of the sky, and a high completion rate of the sky replacement.

In some embodiments, as shown in FIG. 8, an image processing method is provided, and the method is applied to a mobile terminal and includes the following steps.

I. An image is matted by CNN segmenting network.

i. Performing preprocessing on the image: the image to be processed is scaled to a fixed size and then is normalized.

ii. Network segmentation: the preprocessed image to be processed is subjected to network segmentation to obtain a probability image.

II. Post-processing is performed based on segmentation network output.

i. It is determined whether the image to be processed is suitable for replacement of the sky according to the probability image.

ii. If it is not suitable to replace the sky, a corresponding comprehensive filter is selected according to a target sky scene and is applied to the image to be processed to directly obtain a processed image.

iii. If it is suitable to replace the sky, the following steps are executed.

(i) Optimizing the probability image based on statistic information: a minimum blue channel value (minBlue) in an area with a probability value more than 0.95 in the image to be processed is counted. A histogram of a blue channel in an area with a probability value more than 0.9 in the image to be processed is calculated, and an interval Qi with a largest number of blue channel pixel values is calculated according to the histogram. A probability value corresponding to an area where the blue channel is less than minBlue in the probability image is decreased by half. A probability value in the probability image having a probability value greater than 0.5 and being in the Qi interval is set as 1.0.

(ii) Guided filter feathering: the image to be processed is converted from an RGB image to a greyscale image, and the guided filtering is performed on the optimized probability image by using the greyscale image as a guide image to obtain a feathered probability image.

(iii) Cropping sky material: a minimum rectangular bounding box of the sky area in the image to be processed is calculated according to the feathered probability image, and the sky material is cropped and scaled to a size of the rectangular bounding box while maintaining an aspect ratio.

(iv) Adaptive foreground adjustment: brightness, contrast, and saturation of the foreground image in the image to be processed are adjusted according to the target sky scene to match the style of the material. Beautifying is performed by using a foreground filter corresponding to the target sky scene to obtain a final foreground image.

(v) Segmented fusion: the adjusted foreground image and the cropped sky material are fused according to the feathered probability image.

(vi) A corresponding overall filter is selected according to the target sky scene, and the fused image is processed through the overall filter to obtain a processed image.

The above-mentioned embodiment has the following technical effects. By combination with the use of the AI segmentation model and the optimization of segmentation results in post-processing, it is possible to better complete the accurate matting of the sky area, and effectively avoid defects caused by matting errors, such as loss of wires in the sky, no replacement of sky in tree holes.

In the post-processing, the new sky area is fused with the original image background by using segmented layer aliasing and segmented linear fusion, such that a transition between the sky area and the non-sky area of the synthesized image is real and natural.

According to the type of material (target sky scene), the non-sky area (i.e., the foreground image) is adjusted in a targeted manner, and the color is overall adjusted finally, which ensures the unity and beauty of the final effect image.

By integrating the above-mentioned three effects, a natural and real sky replacement effect with a high completion rate is realized, such that it is possible for a user to efficiently process an image with outdoor sky by single-click matting operation.

It should be understood that although the steps in the flowcharts of FIGS. 2, 7 and 8 are sequentially displayed according to the arrows, these steps are not necessarily executed in the order indicated by the arrows. Unless explicitly stated herein, the execution of these steps is not strictly limited to the order, and the steps may be executed in other orders. Moreover, at least a part of the steps in FIGS. 2, 7, and 8 may include multiple steps or multiple stages, and these steps or stages are not necessarily executed at the same time, but may be executed at different moments.

The order of execution of these steps or stages is also not necessarily sequential, but may be performed in turn or alternately with other steps or at least a portion of the steps or stages in the other steps.

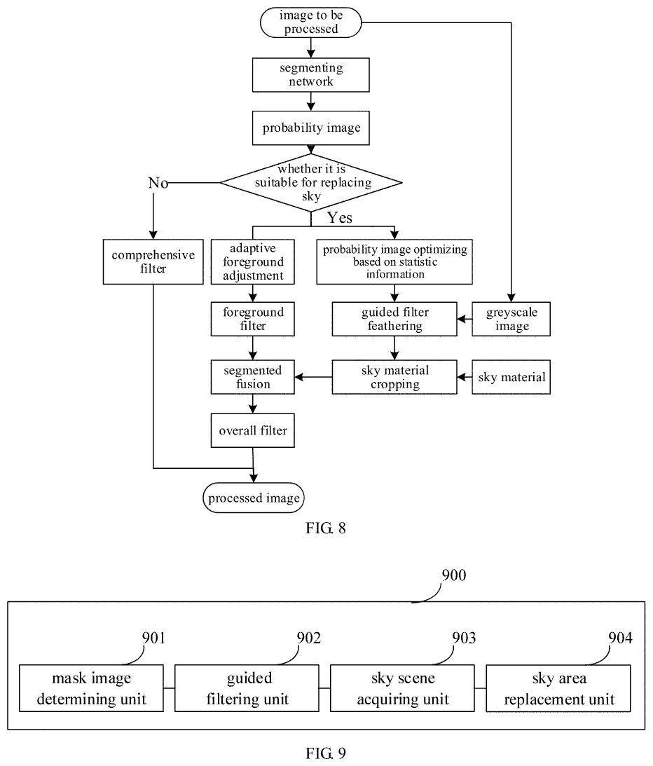

FIG. 9 is a block diagram of an image processing device 900 according to an embodiment of the present disclosure. Referring to FIG. 9, the device includes a mask image determining unit 901, a guided filtering unit 902, a sky scene acquiring unit 903 and a sky area replacement unit 904.

The mask image determining unit 901 is configured to perform image segmentation on an image to be processed, and obtain an initial mask image according to an image segmentation result. The initial mask image includes a probability value of each pixel point in the image to be processed belonging to pixel points in a sky area.

The guided filtering unit 902 is configured to obtain a target mask image by performing guided filtering on the initial mask image by using a greyscale image of the image to be processed as a guide image in response to determining that the image to be processed satisfies a preset sky area replacement condition according to the initial mask image.

The sky scene acquiring unit 903 is configured to acquire a target sky scene. The target sky scene is selected from preset sky scene materials.

The sky area replacement unit 904 is configured to obtain a first processed image by performing replacement on the sky area in the image to be processed according to the target mask image and the target sky scene.

In some embodiments, the guided filtering unit includes a pixel value acquiring subunit, a first pixel point determining subunit, a second pixel point determining subunit, a probability value processing subunit and a guided filtering subunit. The pixel value acquiring subunit is configured to acquire a blue channel pixel value of each pixel point in the image to be processed. The first pixel point determining subunit is configured to determine as a first pixel point a pixel point having a blue channel pixel value within a target distribution interval and a probability value greater than a first threshold in the initial mask image. The target distribution interval is an interval having a largest number of blue channel pixel values of pixel points in a first evaluation area among a plurality of preset intervals, and the first evaluation area is an area where a pixel point having a probability value greater than a second threshold is located in the initial mask image. The second threshold is greater than the first threshold. The second pixel point determining subunit is configured to determine as a second pixel point a pixel point having a blue channel pixel value less than a target blue channel pixel value in the initial mask image. The target blue channel pixel value is a minimum value of blue channel pixel values of pixel points in a second evaluation area, and the second evaluation area is an area where a pixel point having a probability value greater than a third threshold in the initial mask image is located. The third threshold is greater than the second threshold. The probability value processing subunit is configured to increase a probability value of the first pixel point, and decrease a probability value of the second pixel point to obtain a reference mask image. The guided filtering subunit is configured to perform guided filtering on the reference mask image by using the greyscale image of the image to be processed as the guide image to obtain the target mask image.

In some embodiments, the guided filtering subunit includes a first probability value setting module and a second probability value setting module. The first probability value setting module is configured to set the probability value of the first pixel point as 1, and the second probability value setting module is configured to decrease the probability value of the second pixel point by half.

In some embodiments, the sky area replacement unit includes a foreground image determining subunit, a sky material cropping subunit and a first foreground composing subunit.

The foreground image determining subunit is configured to determine a non-sky area in the image to be processed as a foreground image. The sky material cropping subunit is configured to crop a sky material image according to the target sky scene and a size of the sky area to obtain a target sky image having a scene corresponding to the target sky scene and a size corresponding to the size of the sky area. The first foreground composing subunit is configured to compose the foreground image and the target sky image according to the target mask image to obtain the first processed image, wherein the sky area in the first processed image is replaced by the target sky image.

In some embodiments, the sky area replacement unit further includes an area determining subunit, a sky image replacement subunit, a foreground image replacement subunit, a channel information fusion subunit and a processed image acquiring subunit. The area determining subunit is configured to determine a first area, a second area and a remaining area of the image to be processed according to the target mask image. A probability value of a pixel point contained in the first area is 1, a probability value of a pixel point contained in the second area is 0, and the remaining area is an area other than the first area and the second area in the image to be processed. The sky image replacement subunit is configured to replace the first area with the target sky image.

The foreground image replacement subunit is configured to replace the second area with the foreground image. The channel information fusion subunit is configured to perform color channel information fusion on pixel points of the foreground image and the target sky image according to a probability value, a red channel pixel value, a green channel pixel value and a blue channel pixel value corresponding to the remaining area. The processed image acquiring subunit is configured to obtain the first processed image according to the target sky image after performing the color channel information fusion.

In some embodiments, the sky area replacement unit further includes a foreground image adjustment subunit and a second foreground composing subunit. The foreground image adjustment subunit is configured to adjust at least one of brightness, contrast and saturation of the foreground image according to the target sky scene to obtain a target foreground image having brightness, contrast and saturation matching the target sky scene. The second foreground composing subunit is configured to compose the target foreground image and the target sky image according to the target mask image to obtain the first processed image.

In some embodiments, the guided filtering unit is further configured to determine whether the image to be processed satisfies at least one of the following preset conditions (i) to (iv) according to the initial mask image. If at least one of the following preset conditions is satisfied, it is determined that the image to be processed does not satisfy the sky area replacement condition, and if any one of the following preset conditions is not satisfied, it is determined that the image to be processed satisfies the sky area replacement condition.

(i) A first proportion of the sky area in the image to be processed is less than a preset fourth threshold.

(ii) A second proportion of a non-confidence area in the image to be processed is greater than a preset fifth threshold, wherein the non-confidence area is an area where a probability value of each pixel is in a middle interval, and the middle interval consists of a median of the probability values and adjacent values of the median.

(iii) An average brightness of the sky area in the image to be processed is less than a preset sixth threshold.

(iv) A third proportion of a target dark channel area in the image to be processed is greater than a preset seventh threshold, wherein the target dark channel area is an area in the sky area where a pixel point having a dark channel value less than an eighth threshold is located.

In some embodiments, the image processing device further includes a filtering unit, and the filtering unit is configured to acquire a target filtering tool according to the target sky scene in response to the sky area replacement condition being not satisfied, and perform filtering on the image to be processed by the target filtering tool to obtain a second processed image.

Regarding the device in the above-mentioned embodiments, the specific manner in which each module performs the operation has been described in detail in the embodiments of the method, which will not be described in detail here.

In some embodiments, there is also provided a non-transitory computer-readable storage medium including instructions, such as the memory 102 including instructions, executable by the processor 109 in the device 100, for performing the above-described methods. For example, the non-transitory computer-readable storage medium may be a read-only memory (ROM), a random access memory (RAM), a CD-ROM, a magnetic tape, a floppy disc, an optical data storage device, and the like.

According to a fifth aspect of embodiments in the present disclosure, there is provided a computer program product. The program product includes a computer program, and the computer program is stored in a readable storage medium. When the computer program is read from the readable storage medium and executed by at least one processor of a device, the device is configured to perform the above-mentioned image processing method.

Other embodiments of the present disclosure will be apparent to those skilled in the art from consideration of the specification and practice of the present disclosure disclosed herein. The present disclosure is intended to cover any variations, uses, or adaptive modifications of the present disclosure following the general principles thereof and including common general knowledge or conventional techniques in the art not disclosed by this disclosure. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the present disclosure only be limited by the appended claims.

What is claimed is:

1. An image processing method, comprising:
performing image segmentation on a first image which is to be processed;
obtaining an initial mask image according to an image segmentation result, wherein the initial mask image comprises a probability value of each pixel point in the first image belonging to pixel points in a sky area;
in response to determining that the first image satisfies a preset sky area replacement condition according to the initial mask image, obtaining a target mask image by performing guided filtering on the initial mask image by using a greyscale image of the first image as a guide image;
acquiring a target sky scene, wherein the target sky scene is selected from preset sky scene materials;
obtaining a second image by performing replacement on the sky area in the first image according to the target mask image and the target sky scene.

2. The image processing method according to claim 1, wherein said obtaining a target mask image by performing guided filtering on the initial mask image by using a greyscale image of the first image as a guide image comprises:
acquiring a blue channel pixel value of each pixel point in the first image;
determining a first pixel point based on a pixel point having a blue channel pixel value within a target distribution interval and a probability value greater than a first threshold in the initial mask image, wherein the target distribution interval is an interval having a largest number of blue channel pixel values of pixel points in a first evaluation area among a plurality of preset intervals, and the first evaluation area is an area where a pixel point having a probability value greater than a second threshold is located in the initial mask image, wherein the second threshold is greater than the first threshold;
determining a second pixel point based on a pixel point having a blue channel pixel value less than a target value in the initial mask image, wherein the target value is a minimum value of blue channel pixel values of pixel points in a second evaluation area, and the second evaluation area is an area where a pixel point having a probability value greater than a third threshold is located in the initial mask image , wherein the third threshold is greater than the second threshold;
obtaining a reference mask image by increasing a probability value of the first pixel point and decreasing a probability value of the second pixel point;
obtaining the target mask image by performing guided filtering on the reference mask image by using the greyscale image of the first image as the guide image.

3. The image processing method according to claim 2, wherein said obtaining a reference mask image by increasing a probability value of the first pixel point and decreasing a probability value of the second pixel point comprises:
setting the probability value of the first pixel point as 1;
decreasing the probability value of the second pixel point by half.

4. The image processing method according to claim 3, wherein said obtaining a second image by performing replacement on the sky area in the first image according to the target mask image and the target sky scene comprises:
determining a foreground image based on a non-sky area in the first image;
obtaining a target sky image by cropping a sky material image according to the target sky scene and a size of the sky area, wherein the target sky image has a scene corresponding to the target sky scene and a size corresponding to the size of the sky area;
obtaining the second image by composing the foreground image and the target sky image according to the target mask image, wherein the sky area in the second image is replaced by the target sky image.

5. The image processing method according to claim 4, wherein said obtaining a second image by performing replacement on the sky area in the first image according to the target mask image and the target sky scene comprises:
determining a first area, a second area and a remaining area of the first image according to the target mask image, wherein a probability value of a pixel point contained in the first area is 1, a probability value of a pixel point contained in the second area is 0, and the remaining area is an area other than the first area and the second area in the first image;
replacing the first area with the target sky image;
replacing the second area with the foreground image;
performing color channel information fusion on pixel points of the foreground image and the target sky image according to a probability value, a red channel pixel value, a green channel pixel value and a blue channel pixel value corresponding to the remaining area;
obtaining the second image according to the target sky image after performing the color channel information fusion.

6. The image processing method according to claim 4, wherein said obtaining the second image by composing the foreground image and the target sky image according to the target mask image comprises:
obtaining a target foreground image by adjusting at least one of brightness, contrast and saturation of the foreground image according to the target sky scene, wherein the target foreground image has brightness, contrast and saturation matching the target sky scene;
obtaining the second image by composing the target foreground image and the target sky image according to the target mask image.

7. The image processing method according to claim 1, wherein if at least one of the following preset conditions is satisfied, determining that the first image does not satisfy the sky area replacement condition; if any one of the following preset conditions is not satisfied, determining that the first image satisfies the sky area replacement condition:
(i) a first proportion of the sky area in the first image is less than a preset fourth threshold;
(ii) a second proportion of a non-confidence area in the first image is greater than a preset fifth threshold, wherein the non-confidence area is an area where a probability value of each pixel is in a middle interval, and the middle interval comprises a median of the probability values and adjacent values of the median;
(iii) an average brightness of the sky area in the first image is less than a preset sixth threshold;
(iv) a third proportion of a target dark channel area in the first image is greater than a preset seventh threshold, wherein the target dark channel area is an area in the sky area where a pixel point having a dark channel value less than an eighth threshold is located.

8. The image processing method according to claim 7, wherein the method further comprises:
acquiring a target filtering tool according to the target sky scene in response to the sky area replacement condition being not satisfied; and
obtaining a third image by performing filtering on the first image by the target filtering tool.

9. An electronic device, comprising:
a processor; and
a memory for storing instructions executable by the processor;
wherein the processor is configured to execute the instructions to:
perform image segmentation on a first image which is to be processed;
obtain an initial mask image according to an image segmentation result, wherein the initial mask image comprises a probability value of each pixel point in the first image belonging to pixel points in a sky area;
in response to determining that the first image satisfies a preset sky area replacement condition according to the initial mask image, obtain a target mask image by performing guided filtering on the initial mask image by using a greyscale image of the first image as a guide image;
acquire a target sky scene, wherein the target sky scene is selected from preset sky scene materials;
obtain a second image by perform replacement on the sky area in the first image according to the target mask image and the target sky scene.

10. The electronic device according to claim 9, wherein the processor is further configured to execute the instructions to:
acquire a blue channel pixel value of each pixel point in the first image;
determine a first pixel point based on a pixel point having a blue channel pixel value within a target distribution interval and a probability value greater than a first threshold in the initial mask image, wherein the target distribution interval is an interval having a largest number of blue channel pixel values of pixel points in a first evaluation area among a plurality of preset intervals, and the first evaluation area is an area where a pixel point having a probability value greater than a second threshold is located in the initial mask image, wherein the second threshold is greater than the first threshold;
determine a second pixel point based on a pixel point having a blue channel pixel value less than a target value in the initial mask image, wherein the target value is a minimum value of blue channel pixel values of pixel points in a second evaluation area, and the second evaluation area is an area where a pixel point having a probability value greater than a third threshold is located in the initial mask image, wherein the third threshold is greater than the second threshold;
obtain a reference mask image by increasing a probability value of the first pixel point and decrease a probability value of the second pixel point;
obtain the target mask image by performing guided filtering on the reference mask image by using the greyscale image of the first image as the guide image.

11. The electronic device according to claim 10, wherein the processor is further configured to execute the instructions to:
set the probability value of the first pixel point as 1;
decrease the probability value of the second pixel point by half

12. The electronic device according to claim 11, wherein the processor is further configured to execute the instructions to:
determine a foreground image based on a non-sky area in the first image;
obtain a target sky image by cropping a sky material image according to the target sky scene and a size of the sky area, wherein the target sky image has a scene corresponding to the target sky scene and a size corresponding to the size of the sky area;
obtain the second image by composing the foreground image and the target sky image according to the target mask image, wherein the sky area in the second image is replaced by the target sky image.

13. The electronic device according to claim 12, wherein the processor is further configured to execute the instructions to:
determine a first area, a second area and a remaining area of the first image according to the target mask image, wherein a probability value of a pixel point contained in the first area is 1, a probability value of a pixel point contained in the second area is 0, and the remaining area is an area other than the first area and the second area in the first image;
replace the first area with the target sky image;
replace the second area with the foreground image;
perform color channel information fusion on pixel points of the foreground image and the target sky image according to a probability value, a red channel pixel value, a green channel pixel value and a blue channel pixel value corresponding to the remaining area;
obtain the second image according to the target sky image after performing the color channel information fusion.

14. The electronic device according to claim 12, wherein the processor is further configured to execute the instructions to:
obtain a target foreground image by adjusting at least one of brightness, contrast and saturation of the foreground image according to the target sky scene, wherein the target foreground image has brightness, contrast and saturation matching the target sky scene;
obtain the second image by composing the target foreground image and the target sky image according to the target mask image.

15. The electronic device according to claim 9, wherein the processor is further configured to execute the instructions to:
if at least one of the following preset conditions is satisfied, determine that the first image does not satisfy the sky area replacement condition; if any one of the following preset conditions is not satisfied, determine that the first image satisfies the sky area replacement condition:
(i) a first proportion of the sky area in the first image is less than a preset fourth threshold;
(ii) a second proportion of a non-confidence area in the image to be processed is greater than a preset fifth threshold, wherein the non-confidence area is an area where a probability value of each pixel is in a middle interval, and the middle interval comprises a median of the probability values and adjacent values of the median;
(iii) an average brightness of the sky area in the first image is less than a preset sixth threshold;
(iv) a third proportion of a target dark channel area in the first image is greater than a preset seventh threshold, wherein the target dark channel area is an area in the sky area where a pixel point having a dark channel value less than an eighth threshold is located.

16. The electronic device according to claim 15, wherein the processor is further configured to execute the instructions to:
acquire a target filtering tool according to the target sky scene in response to the sky area replacement condition being not satisfied; and
obtain a third image by performing filtering on the first image by the target filtering tool.

17. A storage medium, having stored therein instructions that, when executed by a processor of an electronic device, cause the electronic device to:
perform image segmentation on a first image which is to be processed;
obtain an initial mask image according to an image segmentation result, wherein the initial mask image comprises a probability value of each pixel point in the first image belonging to pixel points in a sky area;
in response to determining that the first image satisfies a preset sky area replacement condition according to the initial mask image, obtain a target mask image by performing guided filtering on the initial mask image by using a greyscale image of the first image as a guide image;
acquire a target sky scene, wherein the target sky scene is selected from preset sky scene materials;
obtain the second image by performing replacement on the sky area in the first image according to the target mask image and the target sky scene.

18. The storage medium according to claim 17, wherein when the instructions are executed by the processor of the electronic device, the electronic device is configured to:
acquire a blue channel pixel value of each pixel point in the first image;
determine a first pixel point based on a pixel point having a blue channel pixel value within a target distribution interval and a probability value greater than a first threshold in the initial mask image, wherein the target distribution interval is an interval having a largest number of blue channel pixel values of pixel points in a first evaluation area among a plurality of preset intervals, and the first evaluation area is an area where a pixel point having a probability value greater than a second threshold is located in the initial mask image, wherein the second threshold is greater than the first threshold;
determine a second pixel point based on a pixel point having a blue channel pixel value less than a target value in the initial mask image, wherein the target value is a minimum value of blue channel pixel values of pixel points in a second evaluation area, and the second evaluation area is an area where a pixel point having a probability value greater than a third threshold is located in the initial mask image, wherein the third threshold is greater than the second threshold;
obtain a reference mask image by increasing a probability value of the first pixel point and decrease a probability value of the second pixel point;
obtain the target mask image by performing guided filtering on the reference mask image by using the greyscale image of the first image as the guide image.

19. The storage medium according to claim 17, wherein when the instructions are executed by the processor of the electronic device, the electronic device is configured to:
if at least one of the following preset conditions is satisfied, determine that the first image does not satisfy the sky area replacement condition; if any one of the following preset conditions is not satisfied, determine that the first image satisfies the sky area replacement condition:
(i) a first proportion of the sky area in the first image is less than a preset fourth threshold;
(ii) a second proportion of a non-confidence area in the first image is greater than a preset fifth threshold, wherein the non-confidence area is an area where a probability value of each pixel is in a middle interval, and the middle interval comprises a median of the probability values and adjacent values of the median;
(iii) an average brightness of the sky area in the first image is less than a preset sixth threshold;
(iv) a third proportion of a target dark channel area in the first image is greater than a preset seventh threshold, wherein the target dark channel area is an area in the sky area where a pixel point having a dark channel value less than an eighth threshold is located.

20. The storage medium according to claim 19, wherein when the instructions are executed by the processor of the electronic device, the electronic device is configured to:
acquire a target filtering tool according to the target sky scene in response to the sky area replacement condition being not satisfied; and
obtain a third image by performing filtering on the first image by the target filtering tool.
